(19) United States
(12) Patent Application Publication
(10) Pub. No.: US 2011/0091692 A1
(43) Pub. Date: Apr. 21, 2011

(54) POLARIZING COATING HAVING IMPROVED QUALITY

(75) Inventors: Jerome Vivien Davidovits, Thomery (FR); Bruno Dufour, Champagne sur Seine (FR)

(73) Assignee: CORNING INCORPORATED, Corning, NY (US)

(21) Appl. No.: 13/000,141

(22) PCT Filed: Jun. 27, 2008
(86) PCT No.: PCT/IB2008/002766

§ 371 Date: Dec. 20, 2010

(51) Int. Cl. G02B 1/08; B05D 3/00; G02B 5/30

(52) U.S. Cl. 428/172; 427/163.1; 252/585

(57) ABSTRACT

A method of making a polarizing article having high polarization efficiency, low haze, and no visible micro-cracks. The article is made by applying an aqueous polarizing dye solution to a surface of a substrate. The polarizing dye solution comprises at least one ammonium salt of a polarizing azoic dye, an activator, and at least one of an acid and a non-polarizing azoic dye.

### BACKGROUND

The invention relates to polarizing coatings. More particularly, the invention relates to methods of making polarizing coatings on a substrate. Even more particularly, the invention relates to aqueous solutions of polarizing dyes that are used to make such coatings.

Polarized filters selectively absorb reflected glare while transmitting useful light. Such articles are used in various fields such as, for example, ophthalmic lenses, solar protection glasses, filters, and the like. Polarizing lenses have the unique ability to selectively eliminate glare that is reflected from smooth horizontal surfaces, such as water or ice.

Many of the processes that are used to manufacture polarizing articles are based on gluing or imbedding free-standing organic polarizing films or sheets in the article. Such processes cannot be performed in a prescription laboratory, and can only be carried out at a lens manufacture site. Moreover, it is difficult to deform polarizing films enough to match the curvature radius of high power lenses without creating optical distortion. Consequently, these processes are limited in application to low power lenses.

Polarizing articles may also be prepared by depositing a layer comprising liquid crystal dyes directly on a substrate. These dyes are generally water soluble and are very sensitive to environmental conditions, necessitating the addition of several protective layers to produce a finished article. The additional layers decrease the mechanical integrity of the dye layer by inducing cracks in the dye layer, leading to unacceptable cosmetic qualities.

### SUMMARY

The present invention provides a method of making a polarizing article having high polarization efficiency, low haze, and no visible micro-cracks. The article is made by applying an aqueous polarizing dye solution to a surface of a substrate. The polarizing dye solution comprises at least one ammonium salt of a polarizing azoic dye, an activator, and at least one of an acid and a non-polarizing azoic dye.

Accordingly, one aspect of the invention is to provide a method of making a polarizing article having improved polarization efficiency. The method comprises the steps of: providing a light-transmitting substrate; providing an aqueous polarizing dye solution; coating at least one surface of the substrate with the aqueous polarizing dye solution to form a polarizing coating; insolubilizing the polarizing coating with a stabilizing solution; treating the insolubilized polarizing coating with an aqueous silane solution; and curing the solution treated polarizing coating to form the polarized article, wherein the polarizing coating is substantially free of micro-cracks or micro-crazing. The dye solution comprises: an ammonium salt of at least one azoic polarizing dye; an activator, wherein the activator is a non-ionic surfactant; and at least one of an acid and a non-polarizing azoic dye.

A second aspect of the invention is to provide an aqueous polarizing dye solution. The polarizing dye solution comprises: an ammonium salt of at least one polarizing azoic dye; an activator, wherein the activator is a non-ionic surfactant; and at least one of an acid and a non-polarizing azoic dye.

A third aspect of the invention is to provide a polarizing article. The polarizing article comprises: a light-transmitting substrate; a polarizing coating disposed on at least one surface of the substrate, the polarizing coating comprising at least one of a polarizing azoic dye, a non-polarizing azoic dye, and a stabilizer.

These and other aspects, advantages, and salient features of the present invention will become apparent from the following detailed description, the accompanying drawings, and the appended claims.

### BRIEF DESCRIPTION OF THE DRAWINGS

FIG. 1 is a schematic representation of a polarizing article;

FIG. 2 is a schematic representation of a second polarizing article;

FIG. 3 is a photographic image of a polarizing lens prepared using a polarized dye solution containing no acid;

FIG. 4 is a photographic image of a polarizing lens prepared using a polarized dye solution containing hydrochloric acid;

FIG. 5 is a photographic image of a polarizing lens prepared using a polarized dye solution containing trifluoroacetic acid; and

FIG. 6 is a photographic image of a polarizing lens prepared using a polarized dye solution containing azoic dye Acid Yellow 9.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range.

Referring to the drawings in general, it will be understood that the illustrations are for the purpose of describing particular embodiments of the invention and are not intended to limit the invention thereto. The drawings are not necessarily to scale, and certain features and certain views of the drawings may be shown exaggerated in scale or in schematic in the interest of clarity and conciseness.

An aqueous polarizing dye solution is provided. The polarizing dye solution comprises an ammonium salt of at least one polarizing azoic dye, a non-ionic surfactant that serves as an activator, and at least one of an acid and a non-polarizing azoic dye. The dye solution, when used to form a polarizing coating on a substrate, forms a polarizing film that has less haze, as measured by ASTM Standard Test Method for Haze D 1003-07 (also referred to herein as “ASTM haze”), higher polarization efficiency, and less micro-cracking than polarizing coatings that are formed using other vehicles.

The at least one polarizing azoic dye may be a dichroic dye. A single dichroic dye may be used to provide the polarizing effect as well as a desired color or tint to a polarizing article. Alternatively, a solution comprising a combination of such dyes, such as, but not limited to, red, yellow, or blue dyes, may be used to achieve the desired polarization effect and color to the final product.

The at least one polarizing azoic dye may be selected from water soluble “direct” dyes, such as those described in U.S. Pat. No. 5,639,809, entitled “Azo Compounds and Polarizing Films Using the Compounds,” by Yoriaki Matsuzaki et al., filed on Jun. 14, 1995; U.S. Pat. No. 7,108,897, entitled “Dye Type Polarizing Plate,” by Shoji Oiso et al., filed Jul. 26, 2004; U.S. Pat. No. 2,400,877, entitled “Optical Device and Method and Manufacture Thereof,” by Joseph F. Dreyer, filed on Mar. 21, 1961; and International Application WO 00/22463, entitled “Guest-Host Polarizers,” by Hassan Sahouani, having a priority date of Oct. 14, 1998.

Non-limiting examples of the at least one polarizing azoic dye include C.I. (Color Index) Direct Blue 67, C.I. Direct Blue 90, C.I. Direct Green 59, C.I. Direct Violet 48, C.I. Direct Red 39, C.I. Direct Red 79, C.I. Direct Red 81, C.I. Direct Red 83, C.I. Direct Red 89, C.I. Direct Orange 39, C.I. Direct Orange 72, C.I. Direct Yellow 34, C.I. Direct Green 26, C.I. Direct Green 27, C.I. Direct Green 28, C.I. Direct Green 51, and combinations thereof. The structures of these dyes that are known in the art are listed in Table 1. In one non-limiting example, the polarizing dye solution comprises ammonium salts of C.I. Direct Blue 67, C.I. Direct Orange 72, and C.I. Direct Green 27.

The aqueous polarizing dye solution comprises an ammonium salt of the at least one polarizing azoic dye. Other salts, such as sodium salts, potassium salts, and the like, of the at least one polarizing azoic dye may be substituted for a portion of the ammonium salt of the dye. The ammonium salt comprises at least 50% by weight of the total amount of salt added for a particular dye. Whereas crude, unpurified salts of the polarizing azoic dyes may be used, it preferred that the salts first be purified by those methods known in the art.

The concentration of the at least one polarizing azoic dye in the aqueous dye solution is in a range from about 4.6% up to about 5% by weight. Dye concentrations that are in excess of this range result in thicker polarized coatings, which are more susceptible to micro-cracking, whereas dye concentrations that are below the above range produce polarizing coatings that have unsatisfactorily low polarization efficiencies.

TABLE 1

| | |
|---|---|
| C.I. Direct Blue 67 | 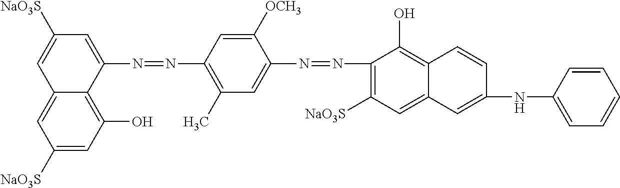 |
| C.I. Direct Orange 72 | 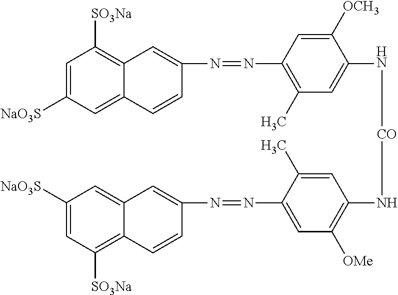 |
| C.I. Direct Red 83 | 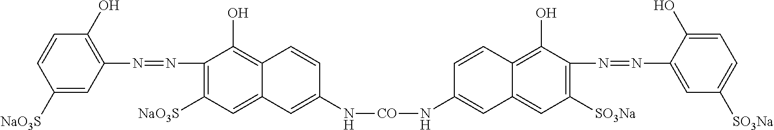 |
| C.I. Direct Green 59 | 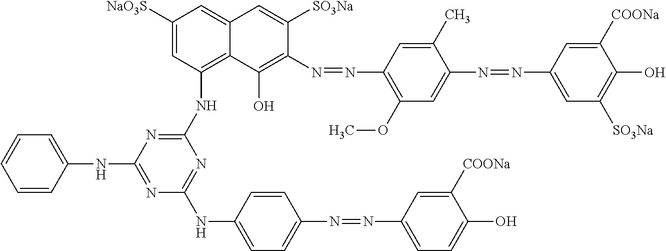 |
| C.I. Direct Violet 48 | 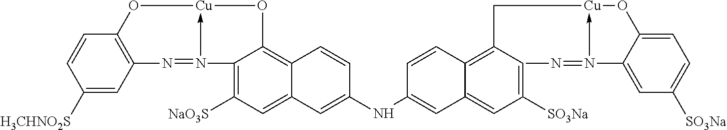 |
| CI Direct Yellow 34 | 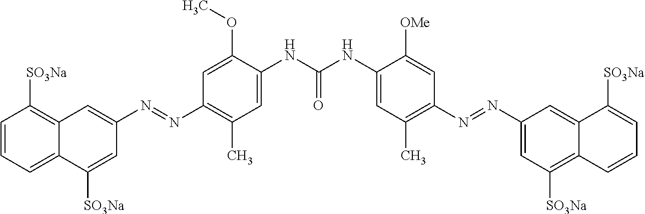 |
| CI Direct Green 26 | 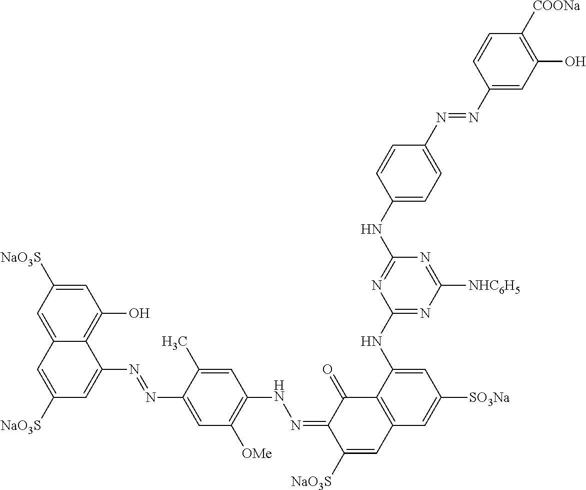 |
| CI Direct Green 51 | 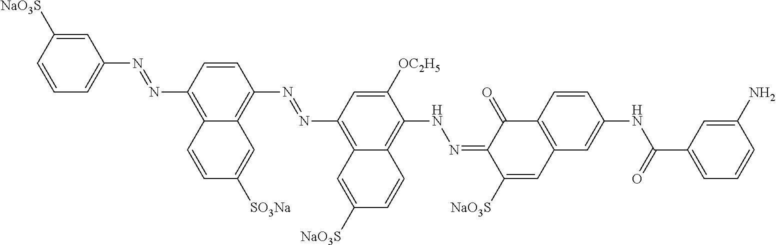 |

The polarizing dye solution also includes an activator that facilitates proper alignment the dye molecules on the brushed or microgrooved surfaces to achieve the polarization effect. The activator is a non-ionic surfactant and, in one embodiment, comprises at least one of poly(ethoxylated) alkylphenols, poly(ethoxylated) nonylphenols, and combinations thereof, as described in European Patent Application 07301075.3, entitled “Light Polarizing Article and Dye Dispersion and Method for Making the Same,” by Jerome Davidovits et al., filed May 30, 2007, the contents of which are incorporated herein by reference in their entirety.

The non-ionic surfactant comprises molecules having the general formula:

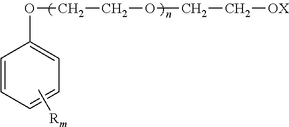

wherein: the average of the number n of all the surfactant molecules ranges from 9 to 200; m is 1 or 2; R, independently and at each occurrence for each surfactant molecule, is an alkyl; at least one R on each surfactant molecule is a C6-C12 straight-chain or branched alkyl; and X, independently and at each occurrence for each surfactant molecule, is an H or a C1-C4 alkyl.

The molecules having the above general formula are known in the art and commercially available. Non-limiting examples of such products include: Tergitol® NP40 and Tergitol® NP10, available from Union Carbide Chemicals & Plastics Technology Corp.; Igepal® CO 720, Igepal® CO 890, Igepal® CA 720, and Igepal® DM 970, available from GAF Corp.; Lutensol® NP100 and Lutensol® NP10, available from BASF; and the like. In particular, Tergitol® NP40 and a combination of Tergitol® NP40 and Igepal® C0720 are advantageous for certain embodiments.

The aqueous polarizing dye solution comprises from about 0.01% up to about 10% activator by weight. In one embodiment, the dye solution comprises from about 0.02% up to about 5% activator by weight and, in yet another embodiment, from about 0.04% up to about 1% activator by weight.

The aqueous polarizing dye solution also comprises at least one of an acid and a non-polarizing azoic dye. The acid may be any organic or inorganic acid that has an ionization constant (pKₐ) of less than or equal to about 5. Non-limiting examples of acids that may be used in the polarizing dye solution include hydrochloric acid, trifluoroacetic acid, and the like. Non-limiting examples of non-polarizing dyes include C.I. Acid Violet 3, C.I. Acid Red 54, C.I. Acid Brown 4, C.I. Acid Violet 1, C.I. Acid Red 34, C.I. Acid Red 33, C.I. Acid Red 30, C.I. Acid Red 231, C.I. Acid Red 37, C.I. Food Yellow 7, C.I. Food Yellow 2, C.I. Acid Orange 59, C.I. Acid Yellow 9, C.I. Acid Red 53, C.I. Mordant Green 30, C.I. Mordant Green 14, C.I. Mordant Green 24, C.I. Solvent Yellow 1, and combinations thereof. The solution includes an amount of acid sufficient to adjust the pH of the polarizing dye solution to a value in a range from about 6 down to about 3 and, in one embodiment, from about 5 down to about 4. In one example, hydrochloric acid is added to the solution to achieve a pH of about 4.1.

A method of making a polarizing article having improved polarization efficiency is also provided. A light transmitting substrate is first provided. The substrate has at least one surface, and may have any shape that is suitable for the final application of the article. The surface may be either planar or contoured. For example, the substrate may be a planar sheet, a cylindrical blank of varying thickness, or, in the case of ophthalmic products such as prescription lenses, a blank having at least one of a concave and convex surface. The light transmitting substrate may, in various embodiments, be photochromic, colored, or colorless. In one embodiment, the surface of the substrate may be coated with a silica layer.

The light-transmitting substrate may be either an inorganic glass substrate or an organic polymer (plastic) substrate, such as those known in the art of ophthalmic lenses and optics. Examples of inorganic glasses that are suitable for use as a substrate include, but are not limited to, alkaline earth aluminosilicate glasses, boroaluminosilicate glasses, doped and undoped fused silica glasses, transparent glass-ceramic materials, crystalline materials such as CaF₂ and MgF₂, and the like. Non-limiting examples of organic polymers that are suitable for the light-transmitting substrate include polyamides, polyesters, polyimides, polysulfones, polycarbonates, polyurethanes, polyurethane-ureas, polyolefins, phenol resins, epoxy resins, homopolymers and copolymers of mono or poly-functional (meth)acrylate, cellulose acetate, cellulose triacetate, cellulose acetate butyrate, cellulose acetate propionate, polyvinyl(acetate), poly(vinyl alcohol), poly(vinyl chloride) and the like.

In those embodiments in which the light-transmitting substrate is an organic polymer, a silica layer may be deposited on the surface to be coated by the polarizing dye solution. The presence of the silica layer improves adhesion of the polarizing dye solution and resulting polarizing coating to the substrate. The silica layer may comprise a stoichiometric, such as SiO₂ or SiO, or a non-stoichiometric (i.e., oxygen-deficient or oxygen-rich) oxide, such as SiO_{y}, where 0.5≦y≦1.8. The silica layer has a thickness of less than about 10 μm. In some embodiments, less than about 5 μm, and, in other embodiments, less than about 1 μm. Such silica layers may be deposited on the substrate by physical or chemical vapor deposition methods known in the art, including plasma or ion-beam sputtering, plasma enhanced chemical vapor deposition (PECVD), low pressure chemical vapor deposition (LPCVD), and the like. In particular, PECVD is a preferred method for depositing the silica layer on an organic polymer substrate, as this deposition technique allows the silica layer to be deposited at much lower temperatures (typically between about 200° C. and about 400° C.) than other chemical vapor deposition techniques.

In one embodiment, a plurality of microgrooves is formed in at least one surface of the light-transmitting substrate. Each of the plurality of microgrooves advantageously has a width and depth that is less than about 1 μm. The microgrooves, in one embodiment, may be parallel to each other. In one embodiment, the light-transmitting substrate forms a portion of a lens such as, for example, a prescription eyeglass lens or a sunglass lens, having a convex (front; i.e., the surface facing away from the user) surface and a concave (back; i.e., the surface facing the user) surface. In those embodiments where the substrate is a glass or a non-stressed plastic such as CR 39 or Tryvex, the microgrooves are formed on the concave side of the substrate. In those embodiments where the lens is a prescription eyeglass lens or a sunglass lens comprising a stressed plastic, the microgrooves are formed on the convex surface.

In one embodiment, the microgrooves are formed on the surface of the light-transmitting substrate by brushing the surface. The surface may be brushed, for example, using a rotating wheel comprising a foam material, such as a polyurethane or polyether foam, an organic sponge material, cotton, or the like that has been soaked with an abrasive slurry. The compositions of such abrasive slurries are known in the art. The slurry typically comprises micron- or sub-micron size abrasive particles that have a higher hardness than the substrate. The abrasive particles may, for example, be particles of titania (TiO₂), alumina (Al₂O₃), zirconia (ZrO₂), ceria (CeO₂), or the like. As will be appreciated by one skilled in the art, the depth and number of microgrooves may be optimized by adjusting process parameters such as, but not limited to, the rotational speed of the wheel, pressure applied to the wheel during brushing, and size, concentration, and hardness of the abrasive particles in the slurry.

An aqueous polarizing dye solution is also provided. As described hereinabove, the aqueous polarizing dye solution comprises an ammonium salt of at least one polarizing azoic dye, an activator, and at least one of an acid and a non-polarizing azoic dye.

A polarizing coating is formed in situ on at least one surface of the light-transmitting substrate by applying the aqueous polarizing dye solution to at least one surface of the substrate. The polarizing dye solution may, in one embodiment, be applied to at least one of a concave surface and a convex surface of the substrate to form the polarizing coating. In those embodiments where a plurality of microgrooves are formed on a surface of the substrate, the polarizing dye solution is applied to the surface having the microgrooves to form the polarized coating, where at least a portion of the polarizing azoic dyes collect in the microgrooves. In some embodiments, the surface having the plurality of microgrooves is a convex surface of the substrate, although, in other embodiments, the surface having the plurality of microgrooves may be a concave surface, as described hereinabove. The surface of the substrate is coated using those methods known in the art, such as, but not limited to, spin coating, dip coating, spray coating, flow coating, web coating, and the like. In those instances where the polarizing dye solution is deposited on the surface of the substrate by spin coating, for example, the drying of the dye solution is controlled by the spinning speed, and temperature and humidity in the chamber in which the coating step is carried out. Haze and polarization efficiency may be measured after drying.

Depending on the final application—for example, whether the particle is a prescription eyeglass lens or a sunglass lens, the polarizing dye solution may be deposited on either a front, convex surface or a back, concave surface. For prescription lenses, the polarizing dye solution is applied to the convex surface of the lens to allow further finishing of the concave surface of the substrate.

The as-deposited polarizing coating or layer is water-soluble. It is therefore desirable to be insolubilized (i.e., made insoluble) and immobilized on the substrate and, in particular, in the plurality of microgrooves when present. The result of such insolubilization is the precipitation of the polarizing azoic dye molecules as inorganic salts that have low solubility in water at room temperature. The polarizing azoic dye molecules are insolubilized by washing the polarizing coating with an aqueous dispersion or solution of at least one metal salt, usually followed by rinsing with deionized water. Such salts may be selected from those salts, such as aluminum salts, iron salts, chromium salts, calcium salts, magnesium salts, barium salts, and the like, that are used in the textile industry to insolubilize dyes in water. In one embodiment, aqueous solutions of chloride salts such as, aluminum chloride (AlCl₃), barium chloride (BaCl₂), cadmium chloride (CdCl₂), zinc chloride (ZnCl₂), tin chloride (SnCl₂), and the like are used to insolubilize the polarizing azoic dyes in the coating. In one particular embodiment, either AlCl₃ or ZnCl₂ are preferred, due to their low toxicity. The aqueous solution used in the insolubilization step may also include at least one of buffers, acids, and multiple salts or bases of various metals. One example of an aqueous dispersion or solution used for such insolubilization is a solution or dispersion comprising aluminum chloride, magnesium hydroxide (Mg(OH)₂), and calcium hydroxide (Ca(OH)₂) having a pH of about 4.

Such precipitated salts of polarizing azoic dyes may still have an unacceptable level of solubility in water at high temperature or may be mobilized after prolonged exposure to sweat. Thus, the method, in some embodiments, may further comprise additional immobilization of the polarizing azoic dye molecules using a polysiloxane. The polarizing coating or layer is washed with an aqueous solution comprising at least one of a siloxane or a prepolymer of at least one siloxane. The siloxane is one of a straight or unbranched chain aminosilane, a branched-chain aminosilane, an aminoalkoxysilane, an aminoalkylsilane, an aminoarylsilane, an aminoaryloxysilane, an epoxyalkyltrialkoxysilane, combinations thereof, derivatives thereof, and salts thereof. Non-limiting examples of such siloxanes include 3-aminopropyltrichlorosilane, 3-aminopropylalkoxyoxysilane, γ-glycidoxypropyltrimethoxysilane, γ-glycidoxypropylpentamethyldisiloxane, γ-glydicoxypropylmethyldiisopropenoxysilane, (γ-glycidoxypropyl)methyldiethoxysilane, γ-glycidoxypropyldimethylethoxysilane, γ-glycidoxypropyldiisopropylethoxysilane, (γ-glycidoxypropyl)bis(trimethylsiloxy)methylsilane, and combinations thereof. The at least one siloxane becomes embedded in the polarizing coating or layer. In one non-limiting example of this second desolubilization, or immobilization, the article is dipped in an aqueous solution containing 10% by weight of 3-aminopropyltrisethoxysilane for 15 minutes after coating at least one surface of the substrate with the polarizing dye solution and after dipping the coated article in an insolubilization solution of AlCl₃. Following dipping in the silane solution, the article is rinsed in deionized water, dried and cured. In one embodiment, the article is dried by blowing pressurized nitrogen or air over the surface of the article. Articles comprising a glass substrate are, in one embodiment, cured by heating a 125° C. for 30 minutes, whereas, in another embodiment, lenses comprising a plastic substrate are cured by heating at 60° C. for 60 minutes. Haze and polarization efficiency of the thus-treated polarizing coating are typically measured after the coating has dried.

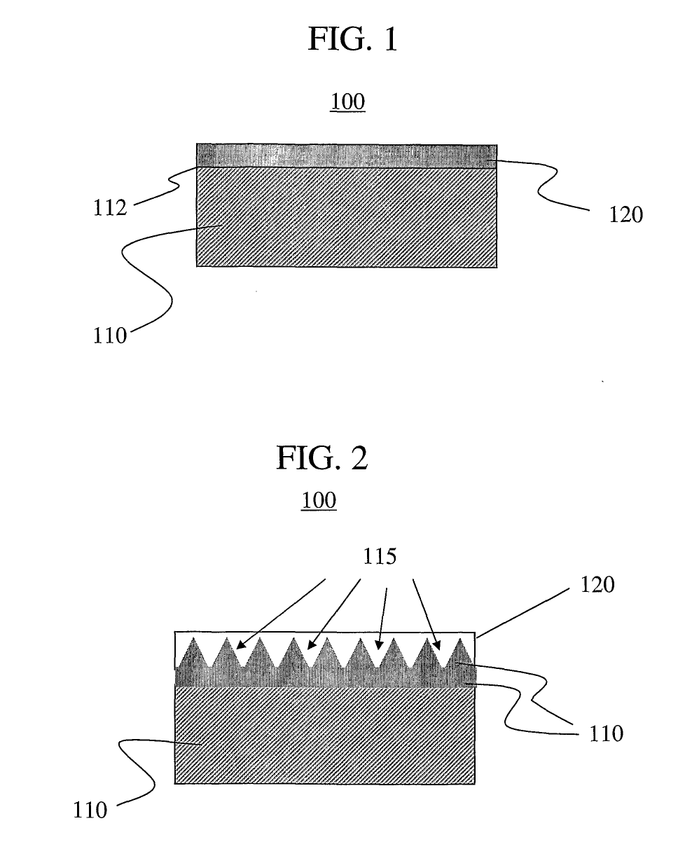

A polarizing article, such as an eyeglass lens, sunglass lens, or the like is also provided. A schematic representation of the polarizing article is shown in FIG. 1. The polarizing article 100 comprises a light-transmitting substrate 110, as previously described hereinabove, and a polarizing coating 120 disposed on at least one surface 112 of light-transmitting substrate 110. In one embodiment, schematically shown in FIG. 2, the polarizing coating 120 is disposed on a surface 112 of light-transmitting substrate 110 having a plurality of microgrooves 115, as described hereinabove.

The polarizing coating comprises at least one polarizing azoic dye. The polarizing coating is deposited on the surface of the light-transmitting substrate by first forming an aqueous solution comprising an ammonium salt of the at least one polarizing azoic dye, an activator and at least one of an acid and a non-polarizing azoic dye and then coating the surface of the light-transmitting substrate with the polarizing dye solution. The polarizing azoic dyes are then desolubilized by washing with an aqueous solution comprising at least one metal salt to form salts of the dyes and then stabilized treating the polarized coating with an aqueous solution comprising at least one silane. The polarizing coating, polarizing dye solution and coating, methods of coating, desolubilizing the polarizing coating, and stabilizing the desolubilized polarized coating have been previously described herein.

The polarizing article may further include additional coatings or layers that are known in the art. Such coatings or layers include, but are not limited to, adhesion or adhesion-promoting, hardcoat or anti-scratch, anti-reflective coatings or layers, and the like.

In one embodiment, the polarizing article has a polarization efficiency of at least 98% and a haze, as determined by ASTM Method D 1003-07 of less than or equal to about 1.0% and, in one embodiment, a polarization efficiency of at least 99% and a haze of less than about 0.30%. In another embodiment, the polarizing coating of the polarizing article is substantially free of micro-cracks and/or micro-crazing.

### EXAMPLES

The following examples illustrate the features and advantages of the invention, and in no way are intended to limit the invention thereto.

For each of the examples described herein, the light-transmitting substrates were prepared and coated with polarizing films as follows.

Substrates are either glass lenses or plastic lenses coated with a silica layer having a convex surface. The convex surface of the substrate is brushed using a spherical polyether foam brush that has been soaked in a water-based alumina slurry. The contact time of the lens with the brush is adapted to the type of material and to the base (radius of curvature) of the lens. The lens is then carefully rinsed with de-ionized water to remove any residue.

The aqueous polarizing dye solution is spin-coated on the convex side of the lens inside a deposition chamber. Drying of the dye solution is controlled by the spinning speed, temperature and humidity in the deposition chamber. Haze and polarization efficiency are measured after the deposited polarizing dye is dried with either compressed nitrogen or air.

In order to protect the water soluble dye layer, the coated lenses are dipped in an aqueous aluminum chloride solution to insolubilize the polarizing dye, and then rinsed in de-ionized water. The lenses are then dipped in an aqueous solution of 3-aminopropyltriethoxysilane (concentration of 10% by weight in the solution) for 15 minutes, rinsed in de-ionized water, dried, and heat cured. Lenses comprising a glass substrate are cured by heating a 125° C. for 30 minutes, whereas lenses comprising a plastic substrate are cured by heating at 60° C. for 60 minutes. Haze, polarization efficiency, and level of cracking in the layer are measured after the silane treatment and curing. The level of cracking is determined using “grazing light (observation with an extended grazing light source),” “grazing micro-crazing (observation with a grazing fiber spotlight),” and “direct micro-crazing (observation with a direct fiber spotlight).”

### Example 1

### Preparation and Characteristization of Polarized Coatings Prepared Using Polarizing Dye Solutions Containing Hydrochloric Acid

The aqueous polarizing dye solution containing hydrochloric acid is a mixture of: deionized water; a purified (or crude, when available) ammonium salt of the polarizing azoic dye C.I. Direct Blue 67; a purified (or crude, when available) ammonium salt of the polarizing azoic dye C.I. Direct Orange 72; purified (or crude when available) ammonium salt of the polarizing azoic dye C.I. Direct Green 27; hydrochloric acid; and an activator. The activator is a water based solution of a mixture of non-ionic surfactants (70% by weight Tergitol® NP40, available from Union Carbide Chemicals & Plastics Technology Corp.; and 30% by weight of Igepal® CO 720 from GAF Corp.), The activator is added to achieve a concentration of 10% by weight in the aqueous dye solution. The ratio of the weights of dry ammonium salts of the azoic dyes that are added to the solution is 300 parts C.I. Direct Blue 67 to 400 parts C.I. Direct Orange 72 to 900 parts C.I. Direct Green 27. The total weight of the polarizing azoic dyes in the solution is adjusted to be 4.8% by weight. The amount of HCl added to the solution is sufficient to adjust the pH of the solution to about 4.1.

Properties measured after dye deposition, insolubilization, treatment with silane, and curing of the lens coated with the polarizing dye solution prepared using HCl are listed in Table 2.

### Example 2

### Preparation and Characteristization of Polarized Coatings Polarized Coatings Prepared Using Polarizing Dye Solutions Containing Trifluoroacetic Acid

The aqueous polarizing dye solution containing trifluoroacetic acid is a mixture of: deionized water; a purified (or crude, when available) ammonium salt of the polarizing azoic dye C.I. Direct Blue 67; a purified (or crude, when available) ammonium salt of the polarizing azoic dye C.I. Direct Orange 72; purified (or crude when available) ammonium salt of the polarizing azoic dye C.I. Direct Green 27; trifluoroacetic acid; and an activator. The activator is the same as that described in Example 1. The ratio of the weights of dry ammonium salts of the azoic dyes that are added to the solution is 300 parts Direct Blue 67 to 400 parts Orange 72 to 900 parts Direct Green 27. The total weight of the polarizing azoic dyes in the solution is adjusted to be 4.7% by weight. The amount of trifluoroacetic acid added to the solution is sufficient to adjust the pH of the solution to about 4.1.

Properties measured after dye deposition, insolubilization, treatment with silane, and curing of the lens coated with the polarizing dye solution prepared using trifluoroacetic acid are listed in Table 2.

### Comparative Example 1

### Preparation of Polarizing Dye Solution Without Acid Addition

The aqueous polarizing dye solution containing trifluoroacetic acid is a mixture of: deionized water; a purified (or crude, when available) ammonium salt of the polarizing azoic dye C.I. Direct Blue 67; a purified (or crude, when available) ammonium salt of the polarizing azoic dye C.I. Direct Orange 72; purified (or crude when available) ammonium salt of the polarizing azoic dye C.I. Direct Green 27; and an activator. The activator is the same as that described in Example 1. The ratio of the weights of dry ammonium salts of the azoic dyes that are added to the solution is 300 parts C.I. Direct Blue 67 to 400 parts Orange 72 to 900 parts C.I. Direct Green 27. The total weight of the polarizing azoic dyes in the solution is adjusted to be 4.8% by weight. Properties measured after dye deposition, insolubilization, treatment with silane, and curing of the coated lens are listed in Table 2.

TABLE 2

| | | Exam- | Exam- | Comparative |
|---|---|---|---|---|
| | | ple 1 | ple 2 | Example 1 |
| After dye | ASTM haze (%) | 0.28 | 0.30 | 0.27 |
| deposition | Polarization efficiency | 99.86 | 99.62 | 99.86 |
| | (%) | | | |
| | Grazing light | 0 | 0 | 0 |
| | (Arbitrary Units (AU)) | | | |
| | Grazing Micro-crazing | 0 | 0 | 0 |
| | (AU) | | | |
| | Direct Micro-crazing | 0 | 0 | 0 |
| | (AU) | | | |
| After silane | ASTM haze (%) | 0.30 | 0.49 | 0.70 |
| treatment | Polarization efficiency | 98.87 | 98.62 | 98.87 |
| | (%) | | | |
| and curing | Grazing light (AU) | 0 | 0.2 | 0.3 |
| | Grazing Micro-crazing | 0.1 | 0.5 | 0.6 |
| | (AU) | | | |
| | Direct Micro-crazing | 0 | 0.2 | 0.2 |
| | (AU) | | | |

As seen in Table 2, the lenses prepared with and without addition of acid to the polarizing dye solution exhibit little difference in polarization efficiency and ASTM haze. However, after treatment with silane and curing, the lenses prepared with addition of acid to the polarizing dye solution exhibit significantly less ASTM haze than the lens prepared without addition of acid to the solution. For the solution containing HCl, the lens has less than half the amount of ASTM haze than the lens prepared without addition of acid to the solution. Similarly, the lens prepared using the solution containing trifluoroacetic acid has about 30% less ASTM haze than the lens prepared without addition of acid to the solution.

Similarly, the lenses prepared with addition of acid to the polarizing dye solution exhibit less micro-cracking and micro-crazing. The lens prepared using the HCl dye solution exhibits essentially no cracking under grazing light and direct micro-crazing conditions, and a minimal amount (less than 17% of that measured for the lens prepared using the dye solution containing no acid, although the micro-crazing units are arbitrary and not normalized) of micro-crazing under grazing conditions. The lens prepared using the trifluoroacetic acid dye solution exhibits less cracking and micro-crazing than the lens prepared using the dye solution containing no acid under grazing light and grazing micro-cracking conditions.

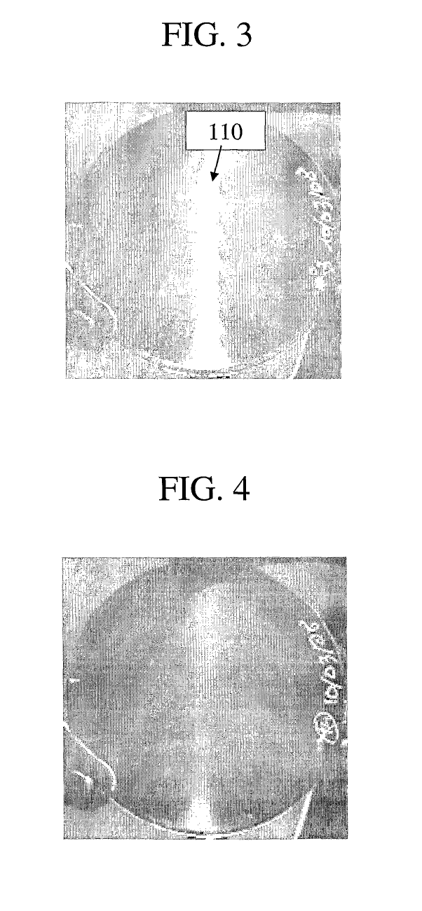

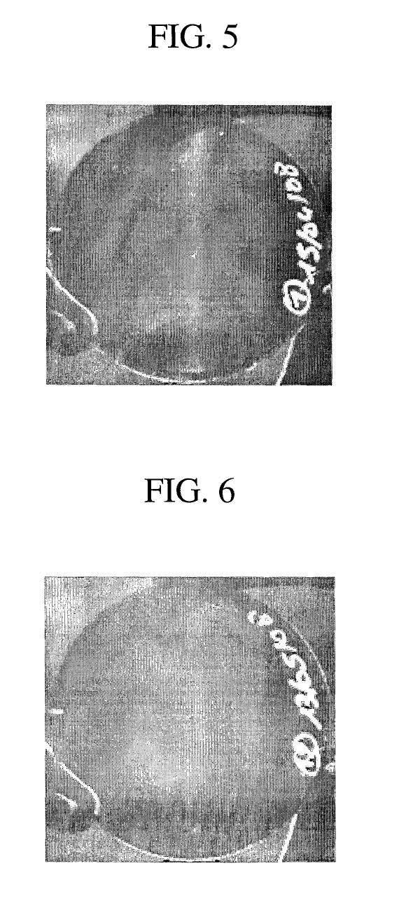

Images of polarized lenses prepared using polarizing dye solutions containing no acid, HCl, and trifluoroacetic acid are shown in FIGS. 3, 4, and 5, respectively. The lenses in FIGS. 3-5 are illuminated with a fiber light spot. When illuminated by the spot, micro-cracks create a white area that is unacceptable in a polarizing lens. The lens prepared using the dye solution containing no acid (FIG. 3) exhibits a broad micro-cracked region 110 across the diameter of the lens, whereas the lenses prepared using dye solutions (FIGS. 4 and 5) containing acid have very faint white regions, indicating little or no discernable micro-cracking.

### Example 3

### Preparation and Characterization of Polarized Coatings Prepared Using Polarizing Dye Solutions Containing Azoic Dye C.I. Acid Yellow 9

The aqueous polarizing dye solution containing the non-polarizing azoic dye Acid Yellow 9 is a mixture of: deionized water; crude (95% pure) C.I. Acid Yellow 9; a purified (or crude, when available) ammonium salt of the polarizing azoic dye C.I. Direct Blue 67; a purified (or crude, when available) ammonium salt of the polarizing azoic dye C.I. Direct Orange 72; purified (or crude when available) ammonium salt of the polarizing azoic dye C.I. Direct Green 27; and an activator. The activator is the same as that described in Example 1. The ratio of the weights of dry ammonium salts of the azoic dyes that are added to the solution is 300 parts C.I. Direct Blue 67 to 400 parts Orange 72 to 900 parts C.I. Direct Green 27 to 27 parts C.I. Acid Yellow 9. The total weight of the polarizing azoic dyes in the solution is adjusted to be 4.8% by weight. Properties measured after dye deposition and after dye deposition, insolubilization, treatment with silane, and curing of the coated lens are listed in Table 3 and compared to the results obtained for Comparative Example 1.

TABLE 3

| | | Exam- | Comparative |
|---|---|---|---|
| | | ple 3 | Example 1 |
| After dye | ASTM haze (%) | 0.27 | 0.27 |
| deposition | Polarization efficiency | 99.62 | 99.86 |
| | (%) | | |
| | Grazing light | 0 | 0 |
| | (Arbitrary Units (AU)) | | |
| | Grazing Micro-crazing | 0 | 0 |
| | (AU) | | |
| | Direct Micro-crazing | 0 | 0 |
| | (AU) | | |
| After silane | ASTM haze (%) | 0.45 | 0.70 |
| treatment | Polarization efficiency | 98.87 | 98.87 |
| | (%) | | |
| and curing | Grazing light (AU) | 0 | 0.3 |
| | Grazing Micro-crazing | 0.2 | 0.6 |
| | (AU) | | |
| | Direct Micro-crazing | 0 | 0.2 |
| | (AU) | | |

The properties of polarizing lenses prepared using a polarizing dye solution containing non-polarizing C.I. Acid Yellow 9 are nearly identical to those of lenses prepared using a dye solution (Comparative Example 1) that did not contain acid or C.I. Acid Yellow 9. Following treatment with silane and curing, however, properties of the polarizing lenses prepared using the dye solution containing C.I. Acid Yellow 9 exhibited 35% less ASTM haze than the lenses prepared using the dye containing no acid or C.I. Acid Yellow 9. In addition, lenses prepared using the dye solution containing non-polarizing C.I. Acid Yellow 9 exhibited essentially no micro-cracking or micro-crazing under grazing light and direct micro-grazing light conditions. Under grazing conditions, lenses prepared using the dye solution containing non-polarizing C.I. Acid Yellow 9 had one third of the micro-crazing seen in the lens prepared from the dye containing no acid or C.I. Acid Yellow 9.

An image of a polarized lens prepared using a polarizing dye solution containing non-polarizing C.I. Acid Yellow 9 is shown in FIG. 6. The lens shown in FIG. 6 is illuminated with a fiber light spot. When illuminated by the spot, micro-cracks, if present, create a bright, white area, such as that seen in the lens prepared in Comparative Example 1 (FIG. 3), that is unacceptable in a polarizing lens. The lens prepared using a dye solution containing non-polarizing dye C.I. Acid Yellow 9 has a faint white region, indicating little or no discernable micro-cracking.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. A method of making a polarizing article having improved polarization efficiency, the method comprising the steps of:
a. providing a light-transmitting substrate;
b. providing an aqueous polarizing dye solution, the dye solution comprising:
i. an ammonium salt of at least one azoic polarizing dye;
ii. an activator, wherein the activator is a non-ionic surfactant; and
iii. at least one of an acid and a non-polarizing azoic dye;
c. coating at least one surface of the substrate with the aqueous polarizing dye solution to form a polarizing coating;
d. insolubilizing the polarizing coating with a stabilizing solution;
e. treating the insolubilized polarizing coating with an aqueous silane solution; and
f. curing the treated polarizing coating to form the polarized article, wherein the polarizing coating is substantially free of micro-cracks.

2. The method of claim 1, wherein the step of providing the substrate comprises forming a plurality of microgrooves on a surface of the substrate, and wherein the step of coating at least one surface of the substrate with the aqueous polarizing dye solution to form the polarizing coating comprises coating the surface on which the microgrooves are formed with the aqueous polarizing dye solution to form the polarizing coating.

3. The method of claim 1, wherein the step of coating the surface of the substrate with the aqueous polarizing dye solution comprises one of spin coating the surface with the dye solution, dip coating the surface with the dye solution, spray coating the surface with the dye solution, web coating the surface with the dye solution, and combinations thereof.

4. The method of claim 1, wherein the step of coating at least one surface of the substrate with the at least one azoic polarizing dye comprises coating at least one of a concave surface and a convex surface of the substrate with the aqueous polarizing azoic dye solution.

5. The method of claim 1, wherein the step of providing the light-transmitting substrate comprises providing one of an inorganic glass substrate and a plastic substrate.

6. The method of claim 1, wherein the stabilizing solution is an aqueous solution of at least one salt of aluminum, iron, chromium, calcium, barium, or magnesium.

7. The method of claim 1, wherein the aqueous silane solution comprises a least one of a straight chain amino silane, a branched-chain aminosilane, an aminoalkoxysilane, an aminoalkylsilane, an aminoarylsilane, an aminoaryloxysilane, an epoxyalkyltrialkoxysilane, combinations thereof, derivatives thereof, and salts thereof.

8. The method of claim 1, wherein the at least one polarizing azoic dye is one of C.I. Direct Blue 67, C.I. Direct Blue 90, C.I. Direct Green 59, C.I. Direct Violet 48, C.I. Direct Red 39, C.I. Direct Red 79, C.I. Direct Red 81, C.I. Direct Red 83, C.I. Direct Red 89, C.I. Direct orange 39, C.I. Direct Orange 72, C.I. Direct Yellow 34, C.I. Direct Green 26, C.I. Direct Green 27, C.I. Direct Green 51, and combinations thereof.

9. The method of claim 1, wherein the acid has a pKₐ of less than or equal to about 5.

10. The method of claim 1, wherein the non-polarizing azoic dye is one of C.I. Acid Violet 3, C.I. Acid Red 54, C.I. Acid Brown 4, C.I. Acid Violet 1, C.I. Acid Red 34, C.I. Acid Red 33, C.I. Acid Red 30, C.I. Acid Red 231, C.I. Acid Red 37, C.I. Food Yellow 7, C.I. Food Yellow 2, C.I. Acid Orange 59, C.I. Acid Yellow 9, C.I. Acid Red 53, C.I. Mordant Green 30, C.I. Mordant Green 14, C.I. Mordant Green 24, C.I. Solvent Yellow 1, and combinations thereof.

11. The method of claim 1, wherein the polarizing article has a polarization efficiency of at least 98%.

12. The method of claim 1, wherein the activator comprises at least one of poly(ethoxylated)alkylphenols, poly(ethoxylated)nonylphenols, and combinations thereof.

13. An aqueous polarizing dye solution, the polarizing dye solution comprising:
a. an ammonium salt of at least one polarizing azoic dye;
b. an activator, wherein the activator is a non-ionic surfactant; and
c. at least one of an acid and a non-polarizing azoic dye.

14. The aqueous polarizing dye solution of claim 13, wherein the at least one polarizing azoic dye is one of C.I. Direct Blue 67, C.I. Direct Blue 90, C.I. Direct Green 59, C.I. Direct Violet 48, C.I. Direct Red 39, C.I. Direct Red 79, C.I. Direct Red 81, C.I. Direct Red 83, C.I. Direct Red 89, C.I. Direct orange 39, C.I. Direct Orange 72, C.I. Direct Yellow 34, C.I. Direct Green 26, C.I. Direct Green 27, C.I. Direct Green 51, and combinations thereof.

15. The aqueous polarizing dye solution of claim 13, wherein the acid has a pK of less than or equal to about 5.

16. The aqueous polarizing dye solution of claim 13, wherein the non-polarizing azoic dye is one of C.I. Acid Violet 3, C.I. Acid Red 54, C.I. Acid Brown 4, C.I. Acid Violet 1, C.I. Acid Red 34, C.I. Acid Red 33, C.I. Acid Red 30, C.I. Acid Red 231, C.I. Acid Red 37, C.I. Food Yellow 7, C.I. Food Yellow 2, C.I. Acid Orange 59, C.I. Acid Yellow 9, C.I. Acid Red 53, C.I. Mordant Green 30, C.I. Mordant Green 14, C.I. Mordant Green 24, C.I. Solvent Yellow 1, and combinations thereof.

17. The aqueous polarizing dye solution of claim 13, wherein the activator comprises at least one of poly(ethoxylated) alkylphenols, poly(ethoxylated) nonylphenols, and combinations thereof.

18. A polarizing article, the polarizing article comprising:
a. a light-transmitting substrate;
b. a polarizing coating disposed on at least one surface of the substrate, the polarizing coating comprising at least one polarizing azoic dye, a non-polarizing azoic dye, and a stabilizer.

19. The polarizing article of claim 18, wherein the surface of the substrate includes a plurality of microgrooves formed thereon.

20. The polarizing article of claim 18, wherein the polarizing article has a polarizing efficiency of at least 98%.

21. The polarizing article of claim 18, wherein the polarizing article has an ASTM haze of less than or equal to about 1.0%.

22. The polarizing article of claim 18, wherein the polarizing article is substantially free of micro-cracks.

23. The polarizing article of claim 18, wherein the at least one polarizing azoic dye is one of C.I. Direct Blue 67, C.I. Direct Blue 90, C.I. Direct Green 59, C.I. Direct Violet 48, C.I. Direct Red 39, C.I. Direct Red 79, C.I. Direct Red 81, C.I. Direct Red 83, C.I. Direct Red 89, C.I. Direct orange 39, C.I. Direct Orange 72, C.I. Direct Yellow 34, C.I. Direct Green 26, C.I. Direct Green 27, C.I. Direct Green 51, and combinations thereof.

24. The polarizing coating of claim 18, wherein the stabilizer comprises at least one of a straight chain amino silane, a branched-chain aminosilane, an aminoalkoxysilane, an aminoalkylsilane, an aminoarylsilane, an aminoaryloxysilane, an epoxyalkyltrialkoxysilane, combinations thereof, derivatives thereof, and salts thereof.

25. The polarizing article of claim 18, wherein the non-polarizing azoic dye is one of C.I. Acid Violet 3, C.I. Acid Red 54, C.I. Acid Brown 4, C.I. Acid Violet 1, C.I. Acid Red 34, C.I. Acid Red 33, C.I. Acid Red 30, C.I. Acid Red 231, C.I. Acid Red 37, C.I. Food Yellow 7, C.I. Food Yellow 2, C.I. Acid Orange 59, C.I. Acid Yellow 9, C.I. Acid Red 53, C.I. Mordant Green 30, C.I. Mordant Green 14, C.I. Mordant Green 24, C.I. Solvent Yellow 1, and combinations thereof.
